(19) United States
(12) Patent Application Publication
(10) Pub. No.: US 2017/0246801 A1
(43) Pub. Date: Aug. 31, 2017

(54) ADDITIVE MANUFACTURING DEVICE

(71) Applicant: HEWLETT-PACKARD DEVELOPMENT COMPANY, L.P., Houston, TX (US)

(72) Inventors: Sam A. Stodder, Carlsbad, CA (US); Morad M. Samii, La Jolla, CA (US); Ben Wynne, San Diego, CA (US)

(73) Assignee: HEWLETT-PACKARD DEVELOPMENT COMPANY, L.P., Houston, TX (US)

(21) Appl. No.: 15/512,015

(22) PCT Filed: Oct. 8, 2014
(86) PCT No.: PCT/US2014/059655

§ 371 Date: Mar. 16, 2017

(51) Int. Cl. B29C 67/00; B33Y 30/00; B33Y 50/02; B33Y 10/00

(52) U.S. Cl. CPC B29C 67/0055; B29C 67/0088; B33Y 10/00; B33Y 30/00; B33Y 50/02

(57) ABSTRACT

An additive manufacturing device for forming a three-dimensional object includes a parking station for receiving a number of removably seated modules and a movable carriage having a carriage latching mechanism for receiving one of the removably seated modules. Movement of the carriage to a module transfers the module to the carriage.

### BACKGROUND

Additive manufacturing system allows for the formation of almost any three dimensional object from the electronic data of a three-dimensional model of the object. The properties of the three-dimensional object may vary depending on the materials used as well as the type of additive manufacturing technology implemented.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a block diagram of an additive manufacturing device according to one example of the principles described herein.

FIG. 2 is a block diagram of an additive manufacturing system according to one example of the principles described herein.

FIG. 3 is an isometric diagram showing a carriage and a module for an additive manufacturing device according to one example of the principles described herein.

FIG. 4 is an isometric diagram showing a parking station and a path for a module according to one example of the principles described herein.

FIG. 5 is an isometric diagram showing an approach of a carriage to a parking station of an additive manufacturing device according to one example of the principles described herein.

FIG. 6 is an isometric diagram showing an engagement of a carriage push bar with a latching arm of a parking station latching mechanism of an additive manufacturing device according to one example of the principles described herein.

FIG. 7 is an isometric diagram showing an engagement of a carriage with a module of an additive manufacturing device according to one example of the principles described herein.

FIG. 8 is an isometric diagram showing the removal of a module from a parking station of an additive manufacturing device according to one example of the principles described herein.

FIG. 9 is a flowchart showing a method of removing a module from a parking station according to one example of the principles described herein.

FIG. 10 is a flowchart showing a method of returning a module to a parking station according to one example of the principles described herein.

Throughout the drawings, identical reference numbers designate similar, but not necessarily identical, elements.

### DETAILED DESCRIPTION

Fused filament fabrication (FFF) modeling is a type of additive manufacturing wherein a material is extruded out of a nozzle. In order to properly extrude the material out of the nozzle, the nozzle is heated sufficiently to soften the material. In some examples, the FFF modeling device may have a number of nozzles from which a number of different types of material are extruded. Each nozzle may add significant weight to the carriage that transports the nozzles. Because of the high temperatures, the nozzles may consist of a heavier material to both sufficiently heat the material and dissipate the heat generated. In order to accommodate the extra weight of each nozzle on the carriage, the carriage and the carriage drive system are designed to move that extra weight. As a result, the carriage and the carriage drive system are larger, more expensive, slower, and create greater friction loads.

Consequently, some carriages may limit the number of nozzles available in order to limit the weight placed on the carriage and carriage drive system. This limitation on the number of nozzles available on the carriage limits the materials available to create a three-dimensional object.

The present specification describes an additive manufacturing device for forming a three-dimensional object including a parking station having a number of removably seated modules, and a movable carriage having a carriage latching mechanism for receiving one of the removably seated modules. Movement of the carriage to a module transfers the module to the carriage.

The present specification further describes a method performed with a processor that includes controlling a carriage of an additive manufacturing device to be moved to a parking station, where the parking station has a number of removably seated modules, and controlling the carriage to transfer one of the removably seated modules from the parking station to the carriage by latching that module to the carriage.

The present specification further describes an additive manufacturing device includes a processor, a parking station where a number of modules are removably seated, and a movable carriage having a carriage latching mechanism. The processor executes instructions to cause the carriage to be coupled to a first module by controlling the carriage to move in a first direction toward a parking station holding the number of modules until the carriage latching mechanism comes in contact with and captures the first module, controlling the carriage to move in a second direction perpendicular to the first direction to unlock the first module from the parking station, and controlling the carriage to move in a third direction parallel and opposite to the first direction such that the carriage latching mechanism pulls the first module out of the parking station.

As used in the present specification and in the appended claims, the term “additive manufacturing device” means any device that fabricates a three-dimensional object from a build material using slices of model data to form corresponding layers of the object.

As used in the present specification and in the appended claims, the term “build material” means a loose or fluid material, for example, a powder, from which a desired three-dimensional object is formed in additive manufacturing.

As used in the present specification and in the appended claims, the term “slice” means a set of model data for a planar cross-section of a three-dimensional object represented electronically by a three-dimensional model from which the “slice” is taken.

As used in the present specification and in the appended claims, the term “layer” means a planar cross-section of a physical, three-dimensional object. In additive manufacturing, a layer of the three-dimensional object corresponds to a slice of the three-dimensional model data.

As used in the present specification and in the appended claims, the term “a number of” means any positive number.

In the following description, for purposes of explanation, numerous specific details are set forth in order to provide a thorough understanding of the present apparatus, systems, and methods. It will be apparent, however, to one skilled in the art that the present apparatus, systems and methods may be practiced without these specific details. Reference in the specification to “an example” or similar language means that a particular feature, structure, or characteristic described in connection with that example is included as described, but may not be included in other examples.

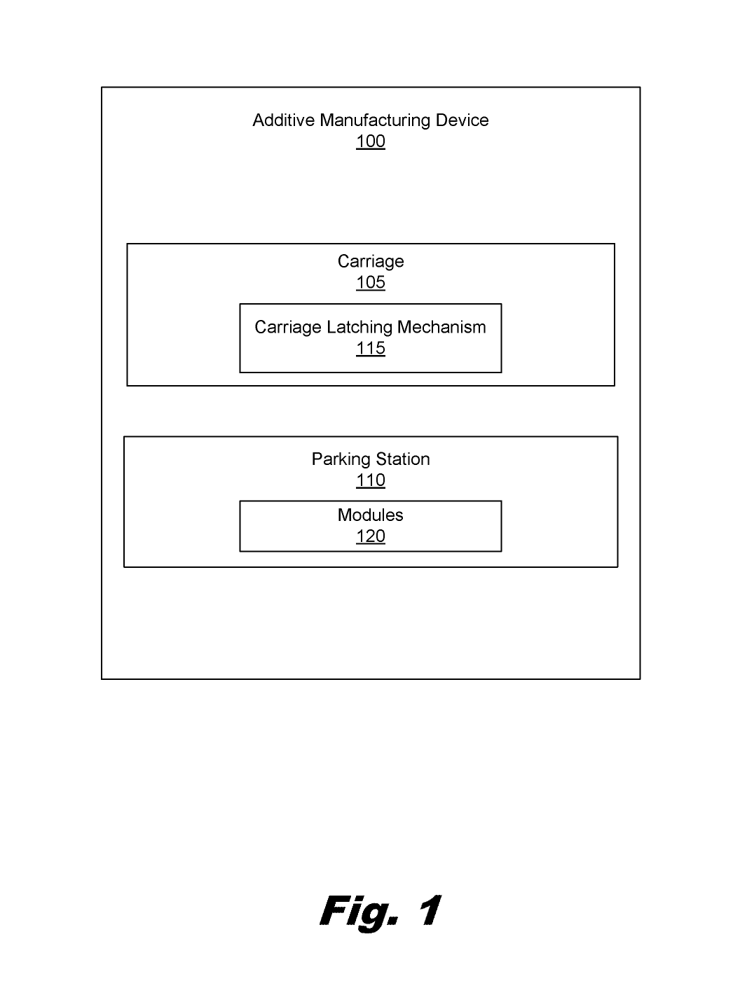

FIG. 1 is a block diagram of an additive manufacturing device (100) according to one example of the principles described herein. The additive manufacturing device (100) includes a carriage (105) and a parking station (110). Each of these components will be described in more detail below.

The carriage (105) has a carriage latching mechanism (115) for selectively coupling to and decoupling from a module (120) removably stored at the parking station (110). The carriage (105) may move to locations where a module (120) is stored and couple, via the carriage latching mechanism (115), that module (120) to the carriage (105). The carriage (105) may move to locations defined by three-dimensional model data received by the additive manufacturing device (100) and, using the coupled module (120), deposit an amount of build material of one or more types according to the three-dimensional model data.

In order to removably couple a number of modules (120) to the carriage (105), the carriage (105) has a carriage latching mechanism (115). The carriage latching mechanism (115) may be any mechanical device that can selectively couple and decouple a number of modules to the carriage (105). The swapping of modules (120) on and off of the carriage (115) allows for a carriage (105) of the additive manufacturing device (100) to have multiple modules available but to carry as few as one single module (120) at a time rather than multiple modules (120). In some examples, the carriage (105) may carry two or more modules using a number of carriage latching mechanisms (115), but less than the total number of modules available for fabrication. As a result, the additive manufacturing device (100) and more specifically, the carriage (105) may be relatively lighter thereby resulting in faster build speeds and less strain on any drive system used to move the carriage (105).

To facilitate the swapping of the modules (120) onto and off of the carriage (105), the additive manufacturing device (100) may further comprise a parking station (110) that stores a number of modules (120) until those modules (120) are to be used. During operation, the carriage (105) may not have a desired module (120). Consequently, the carriage (105) moves relative to the parking station (110) and interfaces with the parking station (110) so as to latch the desired module or modules (120) onto the carriage (105) via the carriage latching mechanism (115). The selection of any one of the number of modules (120) may depend on the type or amount of build material the three-dimensional model data prescribes. The selection of any one of the number of modules (120) may also depend on the function of the module to be used.

The individual modules (120), as described above, may each be mechanically different so as to provide a different type or amount of build material or provide a different function. For example, the module (120) may be a writing head for defining portions of a three-dimensional object. A writing head may comprise a deposition head or a radiation-emitting head.

A set of multiple modules may provide a variety of nozzle diameters sufficient to deposit, from each of the modules (120), a specific gauge of build material. In this example, one module (120) may deposit a relatively larger gauge of extruded build material compared to another module that has a relatively smaller nozzle. As a result, a larger amount of build material may be deposited by one module (120), while a relatively smaller amount is deposited by another module (120).

The different modules (120) may provide different types of build materials with which to build the three-dimensional object. These different types of materials may comprise different filaments. These filaments, when heated, provide the nozzle with build material that may be of different colors, textures, sizes, and durability, among other characteristics.

The selection of modules (130) may also comprise a number of additional tools besides material deposition tools. In one example, a module (130) may be a cutter or a drill. Here, the drill may remove a portion of the three-dimensional object at any time during which the three-dimensional object is being generated. Other examples of modules (130) may comprise a sander, a saw, and a welder, among others. In these examples, the module (130) may comprise a tool that removes any portion of the generated three-dimensional object.

In still another example, the module (130) may provide a tool to apply materials other than the build material described above. Such additional materials may include, for example, coloring agents, electronic leads, integrated circuits, processors, memory devices, and sensors, among others. This type of module (130) may be capable of depositing these materials or devices throughout the three-dimensional object according to the three-dimensional model data received by the additive manufacturing device (100).

In still other examples, the modules (130) may include energy delivery modules (130). In one example, the energy delivery module (130) comprises a laser. In other examples, the energy delivery module comprises different sources of other types of electromagnetic radiation.

As noted, the different types of build material or functions provided via the use of the different modules may allow only a single module (120) to be selectively coupled to the carriage (105) at a time while not limiting the capabilities of the additive manufacturing device (100). In order to hold the modules (130), the parking station (125) may include a number of paths into which the modules (130) may be placed. As will be discussed in more detail below, each path may further comprise a parking station latching mechanism.

The parking station latching mechanism may be used to latch a module (130) to the parking station (125) until addressed and removed by the carriage (115). In one example, advancement of the carriage (115) towards the module (130) uncouples the parking station latching mechanism such that the carriage (115) may remove the module (130) from the path defined in the parking station (125). In another example, a parking station latching actuator may be used to couple or decouple the module (120) to or from the parking station (100) irrespective of the movement of the carriage (105).

The additive manufacturing device (100) may further comprise a processor that comprises hardware architecture used to retrieve executable code from a data storage device and execute the executable code. The executable code may, when executed by the processor, cause the processor to control the carriage (105) to move in a first x-direction toward the parking station until the carriage latching mechanism (115) reaches and captures a module (120) stored in the parking station (110). The processor may control the carriage (105) to move in a first y-direction perpendicular to the x-direction to unlock the module (120) from the parking station. The processor may control the carriage (105) to move in a second x-direction opposite to the first x-direction such that the carriage (105) pulls the module (120) out of the parking station (110). In the course of executing code, the processor may receive input from, and provide output to, a number of the remaining hardware units.

The data storage device described above may store data such as model data for an object being fabricated and executable program code that is executed by the processor or other processing device. The data storage device may specifically store computer code representing a number of applications that the processor executes to implement at least the functionality described herein.

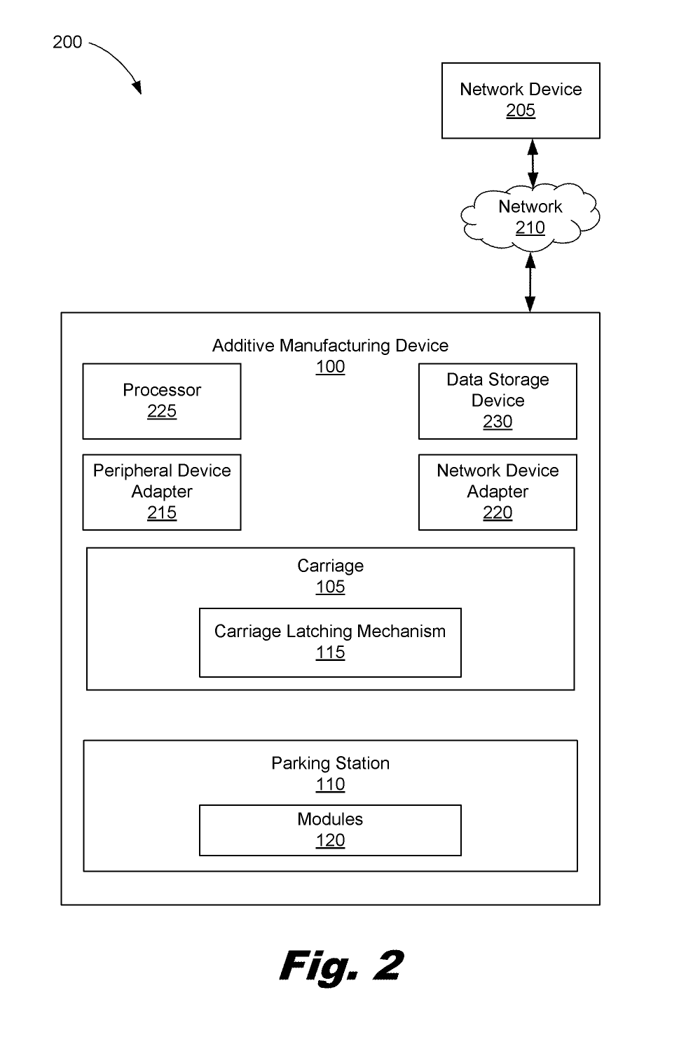

FIG. 2 is a block diagram of a printing system (200) according to one example of the principles described herein. The system (200) may comprise similar elements as described above in connection with FIG. 1. These similar elements may include an additive manufacturing device (100), a carriage (105) with a carriage latching mechanism (115), and a parking station (110) holding a number of modules (120). FIG. 2 further comprises a network device (205), a network (210), a peripheral device adapter (215), a network device adapter (220), a processor (225), and a data storage device (230). Each of these will now be described in more detail.

The network device (205) may be any type of computing device that can, through a network (210), communicate with the additive manufacturing device (100). In one example, the network device (205) is a user client device that provides three-dimensional model data to the additive manufacturing device (100) in order for the additive manufacturing device (100) to, with the processor (225), execute the code stored on the data storage device (230) and fabricate the three-dimensional object using the carriage (105) and modules (120). Other types of network devices (205) exist and the present specification contemplates the use of these devices in connection with the additive manufacturing device (100).

The hardware adapters (215, 220) in the additive manufacturing device (100) enable the processor (225) to interface with various other hardware elements, external and internal to the additive manufacturing device (100). For example, the peripheral device adapters (215) may provide an interface to input/output devices, such as, for example, a display device, a mouse, or a keyboard. The peripheral device adapters (215) may also provide access to other external devices such as an external storage device, a number of network devices such as, for example, servers, switches, and routers, client devices, other types of computing devices, and combinations thereof. The network adapter (220) may provide an interface to other computing devices such as the network device (205) within, for example, a network, thereby enabling the transmission of data between the additive manufacturing device (100) and other devices located within the network. The network (210) may be any type of network including an internet, an extranet, and the Internet, among others.

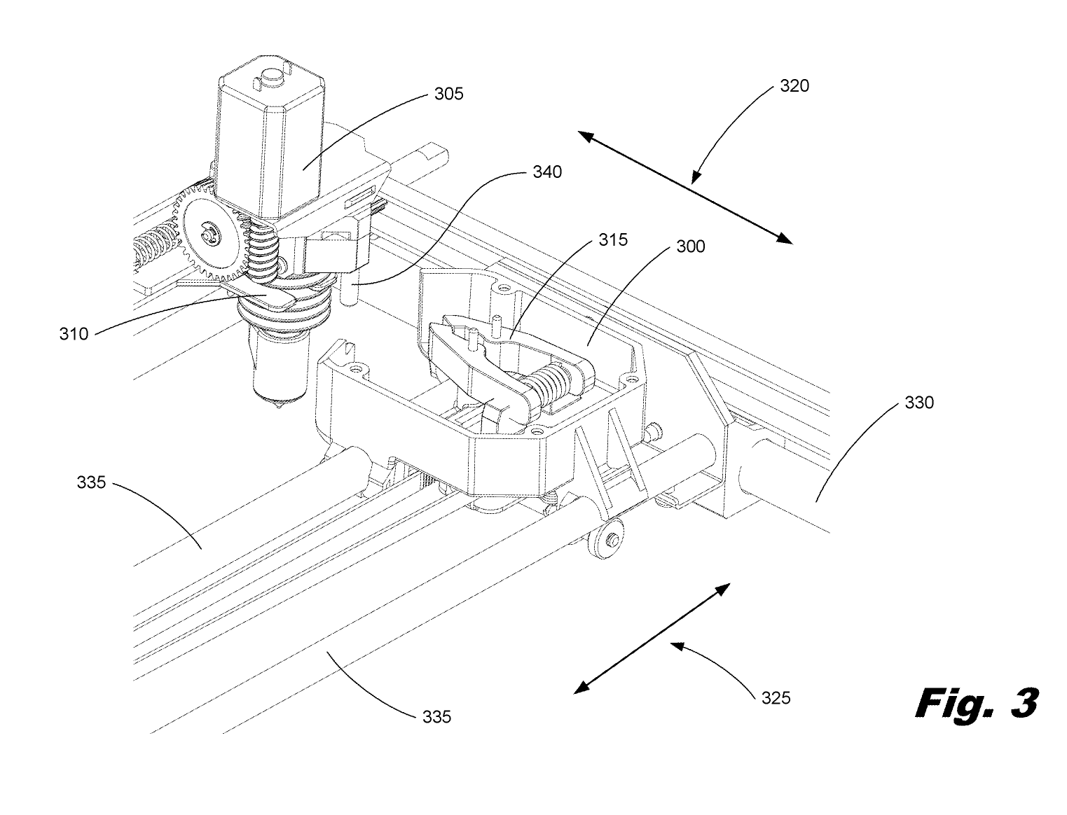

FIG. 3 is an isometric diagram showing a carriage (300) and a module (305) for an additive manufacturing device (FIG. 1, 100; FIG. 2, 100) according to one example of the principles described herein. FIG. 3 shows the carriage (300) without a module (305) coupled thereto. As will be described later, the carriage (300) may retrieve a module (305) from a parking station (310). During the retrieval of the module (305), the carriage (300) may couple the module (305) thereto with a carriage latching mechanism (315).

The carriage (300) may, via a processor (FIG. 2, 225), be controlled to move in a number of directions in order to retrieve a module (305) or use the module (305) to deposit an amount of build material onto a platen. In one example, the carriage (300) is allowed to move in a positive and negative x-direction indicated by an x-axis line (320) in FIG. 3. Additionally, the carriage (300) is allowed to move in a positive and negative y-direction indicated by a y-axis line (325) in FIG. 3. The movement of the carriage (300) in the x- and y-directions may be facilitated by a number of x-direction rails (330) and a number of y-direction rails (335). In one example, the carriage (300) may be allowed to move in a z-direction orthogonal to both the x- and y-directions. In this example, the movement of the carriage (300) in the z-direction may be facilitated through the use of a number of z-direction rails. In another example, a substrate such as a table or platen may be moved in the z-direction relative to the carriage (300).

During operation, as will be discussed below, in order for the carriage (300) to couple a module (305) thereto, the carriage (300) may advance towards a module (305). In order to accomplish this, the carriage (300) may, at least, be directed by the processor (FIG. 2, 225) to move in an x-direction towards a module (305). As the carriage approaches the module (305) the carriage latching mechanism (315) may be aligned with the module (305) such that a portion of the module (315) may addressed by the carriage latching mechanism (315) and so as to secure the module (305) to the carriage (300). In the example shown in FIG. 3, the carriage latching mechanism (315) may come in contact with a module coupling post (340). Any alternative component may be used such that a carriage latching mechanism (315) of any kind comes into contact with and latches onto a portion of the module (305).

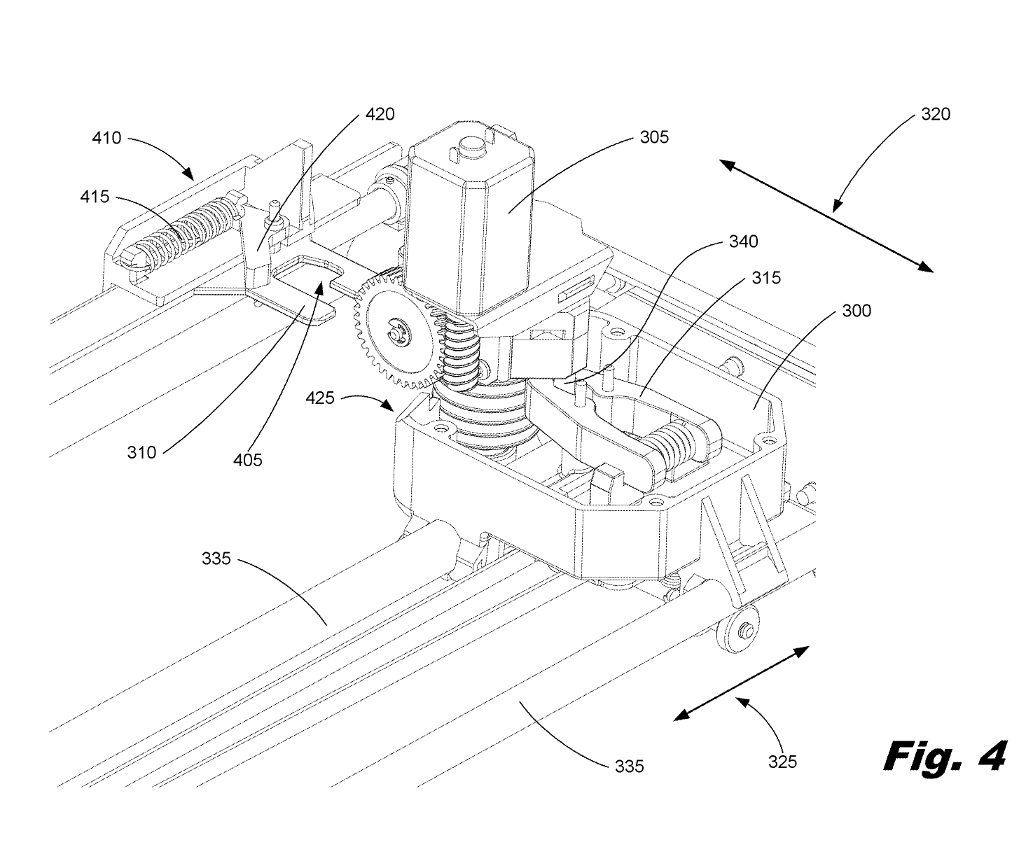

After the carriage (300) latches to the module (305) using the carriage latching mechanism (315), the carriage (300) may move in a y-direction perpendicular to the x-direction. FIG. 4 is an isometric diagram showing a parking station (310) and a path (405) for a module (FIG. 3-FIG. 4, 305) according to one example of the principles described herein. Specifically, FIG. 4 shows the carriage (300) and module (305) in a coupled state and the coupled carriage (300) and module (305) moving in a negative x-direction away from the parking station (310) thereby revealing the parking station (310) and the path (405) defined therein. With reference to both FIGS. 3 and 4, the parking station (310) will now be described.

The parking station (310) may comprise any shape of a path (405) into which a module (305) may be inserted. As is shown in FIG. 4, the path (405) may generally be an L-shaped path (405). That is, the path (405) comprises an x-direction path and a y-direction path perpendicular to and away from the x-direction path and opposite a parking station latching mechanism (410). The parking station latching mechanism (410) may lock the module (305) into the y-direction path of the path (405) through the use of a biased force. In the example shown in FIG. 4, the parking station latching mechanism (410) uses a spring (415) to bias a latching arm (420) in the same direction as the y-direction path of the path (405).

In one example, the parking station latching mechanism (410) is unbiased by a separate unbiasing force when the carriage (300) couples to the module (305) with the carriage latching mechanism (315). In this example, the unbiasing force may be an electro-mechanical device and may be triggered by direction from the processor (FIG. 2, 225). The unbiasing force overcomes the biased force of the spring (415) sufficient to move the latching arm (420) away from the module (305).

In another example, the parking station latching mechanism (410) is unbiased using the force of the movement of the carriage (300). In this example, the carriage (300) may further comprise a carriage push bar (425). The carriage push bar (425) may push the latching arm (420) away from the module (305) thereby allowing the carriage (300) to engage with the module (305) and secure the module (305) to the carriage (300) via the carriage latching mechanism (315).

Although FIGS. 3 and 4 show a single module (305) being parked in a parking station (310), other parking stations may be formed within the additive manufacturing device (FIG. 1, 100; FIG. 2, 100) to hold any number of modules (305). Thus, under the direction of the processor (FIG. 2, 225), the carriage (300) may selectively disengage and engage with a number of different modules (305) parked in a parking station (310).

In one example, the information regarding the placement of each different type of module (305) in each parking station (310) is stored in the data storage device (FIG. 2, 230) of the additive manufacturing device (FIG. 1, 100; FIG. 2, 100) for use during the generation of the three-dimensional object. In this example, the data storage device (FIG. 2, 230) may store the location, type, available build material, and function of the modules (305) available. A user, through the network device (FIG. 2, 205) or a graphical user interface on the additive manufacturing device (FIG. 1, 100; FIG. 2, 100), may cause the data storage device (FIG. 2, 230) to store the information thereby programming the additive manufacturing device (FIG. 1, 100; FIG. 2, 100) to, at least, initially determine where each available module (305) is parked. During generation of the three-dimensional object, the carriage (300) may take and replace each module (305) in the same parking station (310) where that module (305) was designated to be kept. This prevents any use of the wrong module during the printing process.

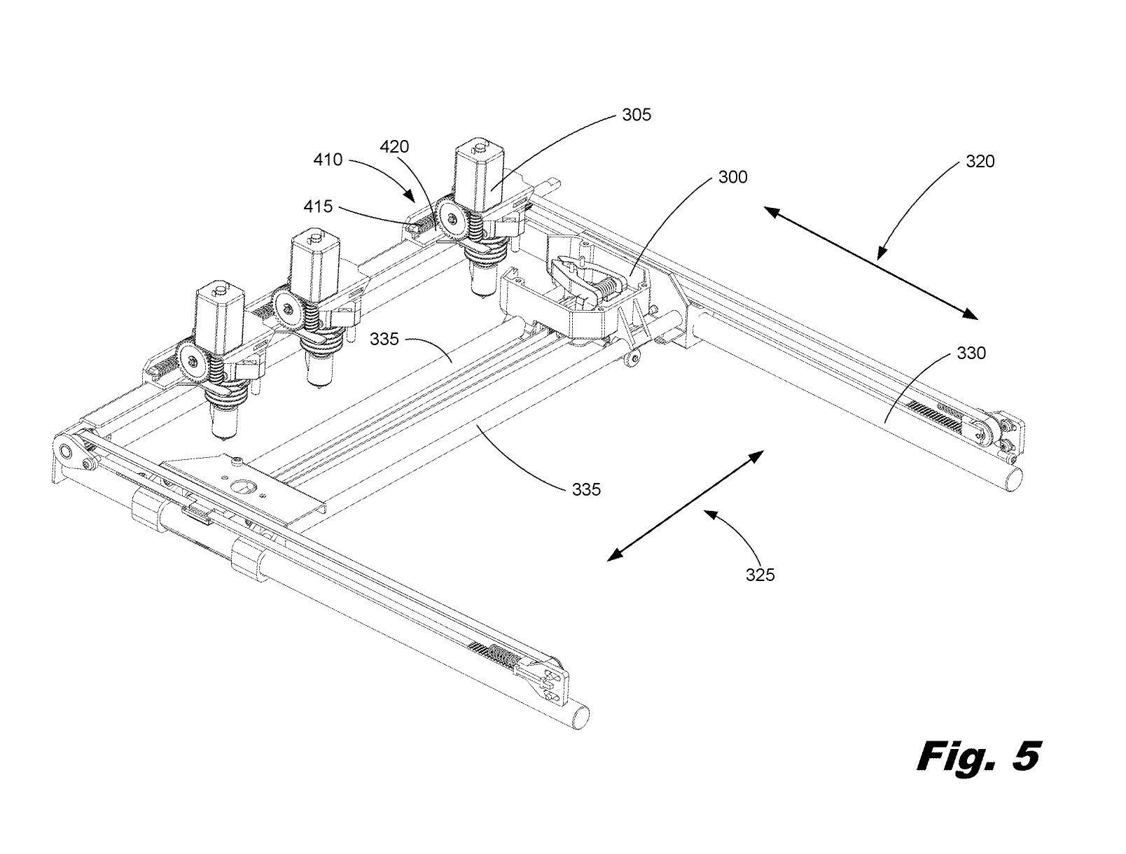

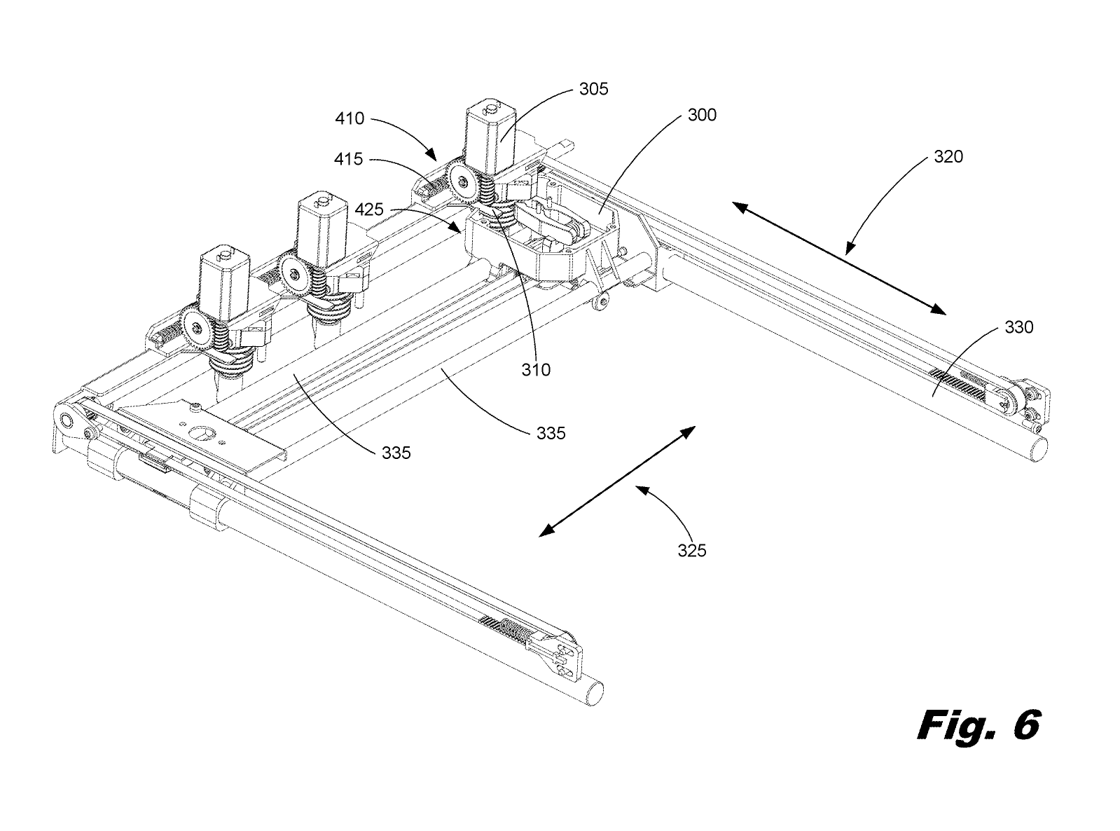

FIGS. 5-8 each show a different stage of a module pick up process as described above in connection with FIGS. 3 and 4. Specifically, FIG. 5 is an isometric diagram showing an approach of a carriage (300) to a parking station (310) of an additive manufacturing device (FIG. 1, 100; FIG. 2, 100) according to one example of the principles described herein. As discussed above, the carriage (300) may move in, at least, an x-direction and align itself with a module (305) according to instructions received from the processor (FIG. 2, 225) of the additive manufacturing device (FIG. 1, 100; FIG. 2, 100). FIG. 6 is an isometric diagram showing an engagement of a carriage push bar (425) with a latching arm (420) of a parking station latching mechanism (410) of an additive manufacturing device (FIG. 1, 100; FIG. 2, 100) according to one example of the principles described herein. Again, in one example, the movement of the carriage (300) in the x-direction pushes the latching arm (420) away from the module (305) parked in the path (405) of the parking station (310) thereby allowing the carriage (300) and, more specifically, the carriage latching mechanism (315) to engage with a part of the module (305).

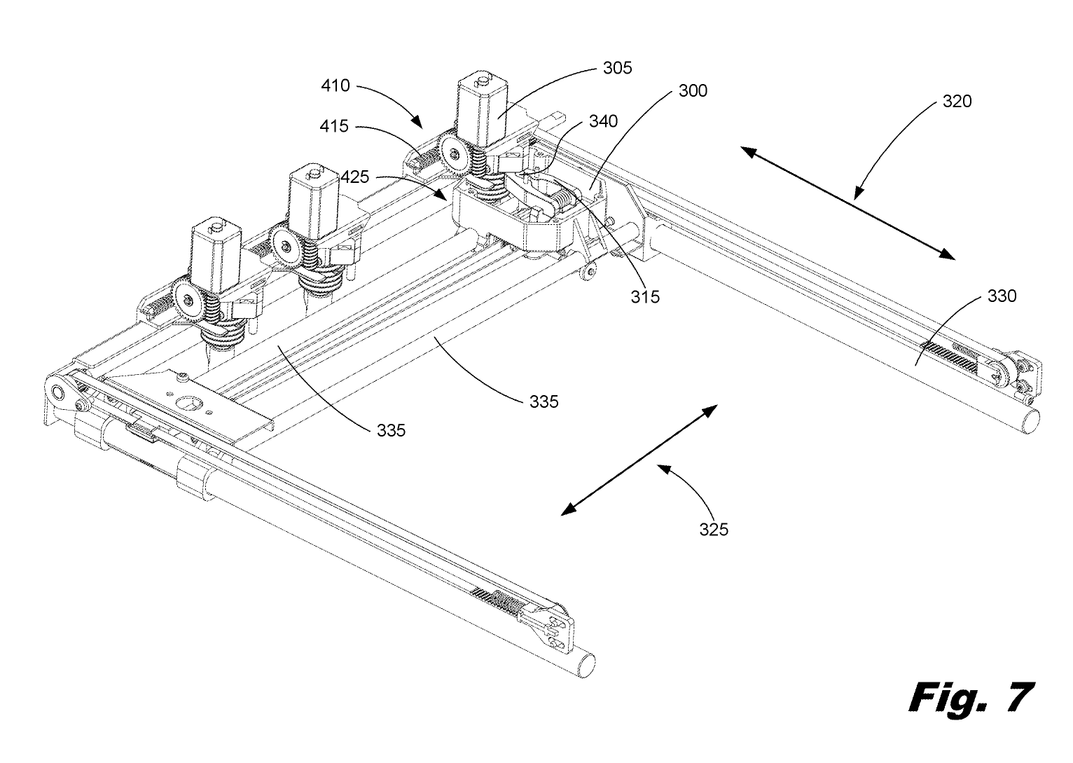

FIG. 7 is an isometric diagram showing an engagement of a carriage (300) with a module (305) of the additive manufacturing device (FIG. 1, 100; FIG. 2, 100) according to one example of the principles described herein. Again, the engagement of the carriage (300) with the module (305) is completed as the carriage (300) continues to move in an x-direction towards the module (305) and its respective parking station (310). Once engagement begins, the carriage latching mechanism (315) engages a part on the module (305) thereby coupling the module to the carriage (300).

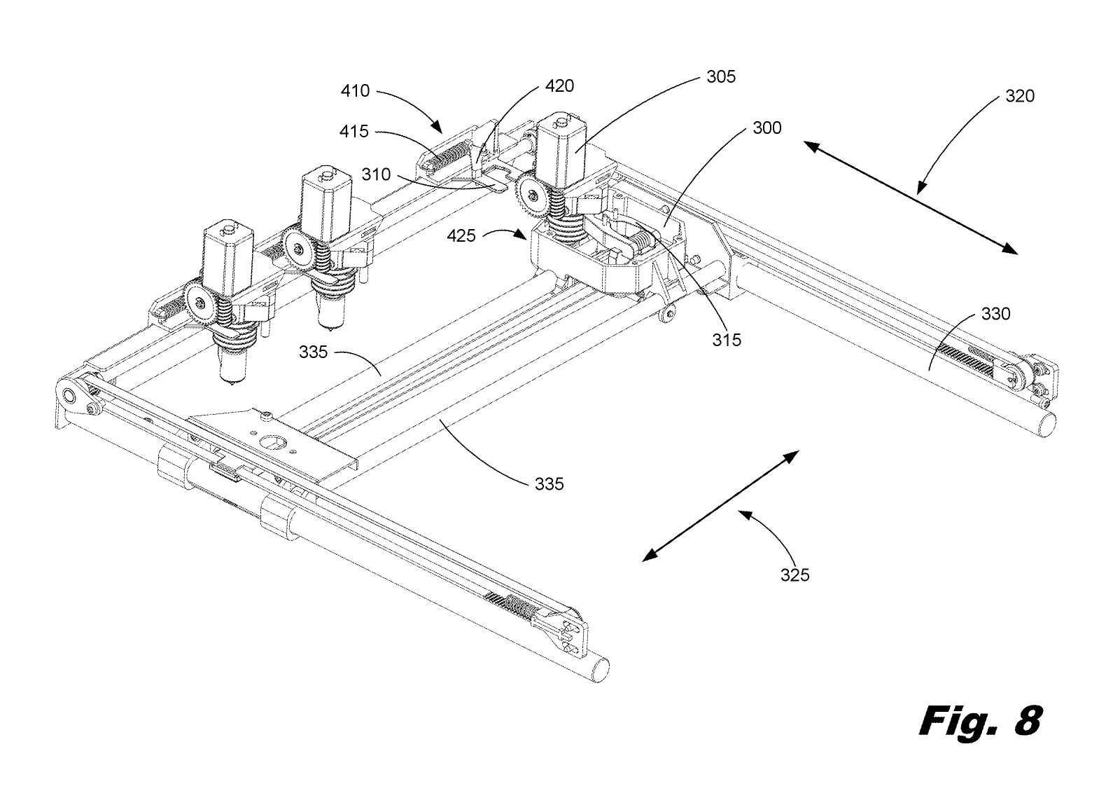

FIG. 8 is an isometric diagram showing the removal of a module (305) from a parking station (310) of an additive manufacturing device (FIG. 1, 100; FIG. 2, 100) according to one example of the principles described herein. Once the module (305) has been coupled to the carriage (300) via the carriage latching mechanism (315), the carriage (300), in this example, may move first in a y-direction opposite the y-direction path of the path (405) defined in the parking station (310). As this is done, the latching arm (420) may be pushed further away from the module (305) via the carriage push bar (425) as described above. Once the module (305) and carriage (300) have proceed as far as possible in the y-direction towards the parking station latching mechanism (410), the carriage (300) may pull the module (305) away from the parking station (310) thereby freeing the module (305) form the parking station (310) while the module (305) is still coupled to the carriage (300).

Having described a series of process by which a module (305) is removed from a parking station (310), the present specification contemplates the parking of the module (305) in its respective parking station (310) as well. In one example, the process by which a module (305) is returned to its respective parking station (310) may be accomplished by reversing the processes described above beginning with the processes described in FIG. 8 and proceeding in reverse order up to the process described in FIG. 5. All of this may be accomplished under the direction of the processor (FIG. 2, 225) and may be completed as the three-dimensional object printing data dictates. For example, during generation of the three-dimensional object, the three-dimensional model data indicates that a different type of build material is to be used; the carriage (300) may return the module (305) to a parking station (310) and retrieve a different module (305) from a separate parking station (310). In this example, the new module is configured to deposit the different type of build material.

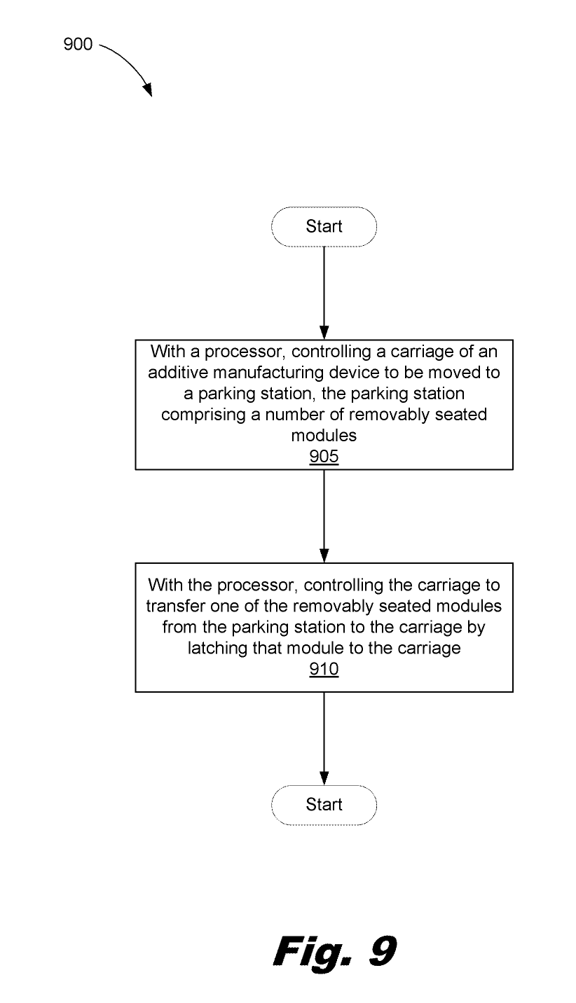

FIG. 9 is a flowchart showing a method (900) of removing a module (FIG. 1, 120; FIG. 2, 120; FIG. 3-FIG. 8, 305) from a parking station (FIG. 1, 110; FIG. 2, 110; FIG. 3, 310) according to one example of the principles described herein. The method (900) may begin with controlling (905), with a processor (FIG. 2, 225), a carriage (FIG. 1, 105, FIG. 2, 105; FIG. 3-FIG. 8, 300) of an additive manufacturing device (FIG. 1, 100; FIG. 2, 100) to be moved in proximity with a parking station (FIG. 1, 110; FIG. 2, 110; FIG. 3, 310). In one example, the carriage (FIG. 1, 105, FIG. 2, 105; FIG. 3-FIG. 8, 300) may be movably supported by a carriage-moving mechanism. In one example, parking station (FIG. 1, 110; FIG. 2, 110; FIG. 3, 310) may comprise a number of removably seated modules (FIG. 1, 120; FIG. 2, 120; FIG. 3-FIG. 8, 305). In this example, at least one of the removably seated modules (FIG. 1, 120; FIG. 2, 120; FIG. 3-FIG. 8, 305) is a writing head for selectively defining portions of the three-dimensional object. The method (900) may continue with controlling (910), with the processor (FIG. 2, 225), the carriage (FIG. 1, 105, FIG. 2, 105; FIG. 3-FIG. 8, 300) to transfer one of the removably seated modules (FIG. 1, 120; FIG. 2, 120; FIG. 3-FIG. 8, 305) from the parking station (FIG. 1, 110; FIG. 2, 110; FIG. 3, 310) to the carriage (FIG. 1, 105, FIG. 2, 105; FIG. 3-FIG. 8, 300) by latching the seated modules (FIG. 1, 120; FIG. 2, 120; FIG. 3-FIG. 8, 305) to the carriage (FIG. 1, 105, FIG. 2, 105; FIG. 3-FIG. 8, 300).

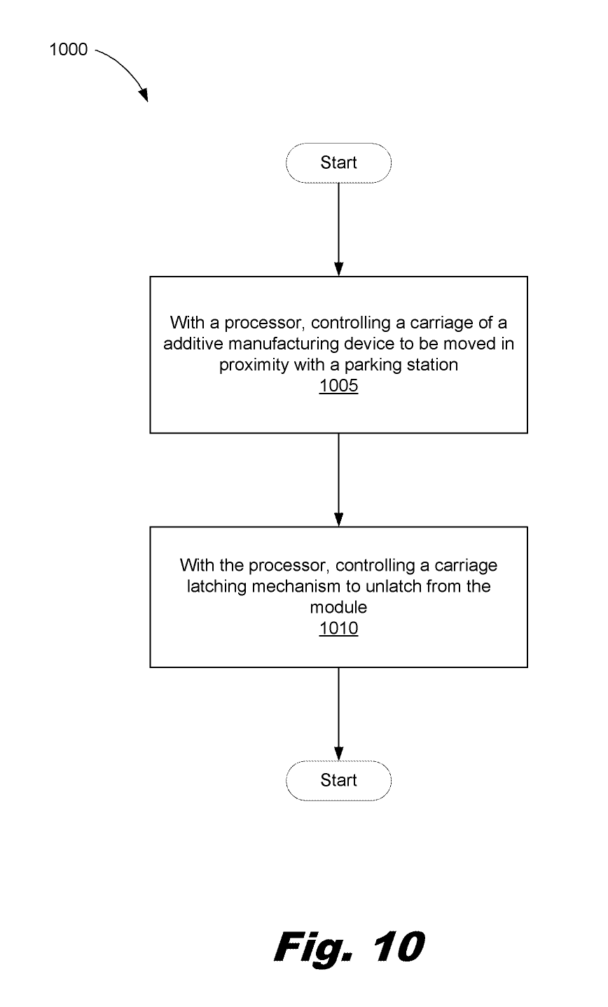

As described above, the modules (FIG. 1, 120; FIG. 2, 120; FIG. 3-FIG. 8, 305) may also be returned to its respective position in the parking station (FIG. 1, 110; FIG. 2, 110; FIG. 3, 310). FIG. 10 is a flowchart showing a method (1000) of returning a module (FIG. 1, 120; FIG. 2, 120; FIG. 3-FIG. 8, 305) to a parking station according to one example of the principles described herein. In one example, this method (1000) may begin after the method (900) described in FIG. 9 is completed. The method (1000) may begin with controlling (1010), with a processor (FIG. 2, 225), a carriage (FIG. 1, 105, FIG. 2, 105; FIG. 3-FIG. 8, 300) of an additive manufacturing device (FIG. 1, 100; FIG. 2, 100) to be moved in proximity with a parking station (FIG. 1, 110; FIG. 2, 110; FIG. 3, 310). In one example, the carriage (FIG. 1, 105, FIG. 2, 105; FIG. 3-FIG. 8, 300) may be movably supported by a carriage-moving mechanism and the parking station (FIG. 1, 110; FIG. 2, 110; FIG. 3, 310) may comprise a number of additional removably seated modules (FIG. 1, 120; FIG. 2, 120; FIG. 3-FIG. 8, 305). The method (1000) may continue with controlling (1010), with the processor (FIG. 2, 225), a carriage latching mechanism (FIG. 1, 115; FIG. 2, 115, FIG. 3-FIG. 8, 315) to unlatch from the module (FIG. 1, 120; FIG. 2, 120; FIG. 3-FIG. 8, 305).

Aspects of the present systems (100, 200) and methods (900, 1000) are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. Computer usable program code may be provided to a processor of a general purpose computer, special purpose computer, or other programmable data processing apparatus to produce a machine, such that the computer usable program code, when executed via, for example, the processor (FIG. 2, 225) of the additive manufacturing device (FIG. 2, 100) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The number of modules (FIG. 1, 120; FIG. 2, 120; FIG. 3-FIG. 8, 305) may include at least one writing head modules and/or deposition head modules for forming a three-dimensional object or article of manufacture. A writing head module is a head that defines portions of a three-dimensional object through either curing or depositing a build material. A writing head module may include light emitters used to selectively cure and/or solidify material to form the object. A deposition head is configured to selectively deposit the material to form the object. Examples of deposition head modules may comprise an FFF modeling head and a UV emitter, and or an inkjet head and UV emitter. The term “writing head” is meant to be understood broadly as any deposition head or light emitter. The present specification, however, contemplates the use of a number of different kinds of writing head modules that can be removably secured in carriage (FIG. 1, 105, FIG. 2, 105; FIG. 3-FIG. 8, 300). In one example, the carriage (FIG. 1, 105, FIG. 2, 105; FIG. 3-FIG. 8, 300) may be moved along two dimensions while the writing head module selectively defines portions of the three-dimensional object.

The preceding description has been presented to illustrate and describe examples of the principles described. This description is not intended to be exhaustive or to limit these principles to any precise form disclosed. Many modifications and variations are possible in light of the above teaching.

While the preceding description has described a particular mechanism for latching and unlatching a modules (FIG. 1, 120; FIG. 2, 120; FIG. 3-FIG. 8, 305) from a carriage (FIG. 1, 105, FIG. 2, 105; FIG. 3-FIG. 8, 300), the present specification contemplates the use of other mechanisms and methods to selectively couple a modules (FIG. 1, 120; FIG. 2, 120; FIG. 3-FIG. 8, 305) to a carriage (FIG. 1, 105, FIG. 2, 105; FIG. 3-FIG. 8, 300). Generally, a carriage movement mechanism may move the carriage (FIG. 1, 105, FIG. 2, 105; FIG. 3-FIG. 8, 300) along a number of axes. The carriage movement mechanism may move the carriage (FIG. 1, 105, FIG. 2, 105; FIG. 3-FIG. 8, 300) to be proximate to or in proximity with a parking station (FIG. 1, 110; FIG. 2, 110; FIG. 3, 310) to enable a transfer of a removably seated modules (FIG. 1, 120; FIG. 2, 120; FIG. 3-FIG. 8, 305) between the parking station (FIG. 1, 110; FIG. 2, 110; FIG. 3, 310) and the carriage (FIG. 1, 105, FIG. 2, 105; FIG. 3-FIG. 8, 300).

The preceding description has described a system (FIG. 2, 200) whereby a removably seated module (FIG. 1, 120; FIG. 2, 120; FIG. 3-FIG. 8, 305) is transferred and latched in response to motion of a carriage (FIG. 1, 105, FIG. 2, 105; FIG. 3-FIG. 8, 300) relative to a parking station (FIG. 1, 110; FIG. 2, 110; FIG. 3, 310). Other mechanisms are possible. For example, the carriage (FIG. 1, 105, FIG. 2, 105; FIG. 3-FIG. 8, 300) or the parking station (FIG. 1, 110; FIG. 2, 110; FIG. 3, 310) may include a latch actuator that actuates a carriage latching mechanism (FIG. 1, 115; FIG. 2, 112; FIG.3-FIG. 8, 315) and/or a parking station latching mechanism (FIG. 3-FIG. 8, 410) in the parking station (FIG. 1, 110; FIG. 2, 110; FIG. 3, 310) without requiring relative movement between the carriage (FIG. 1, 105, FIG. 2, 105; FIG. 3-FIG. 8, 300) and the parking station (FIG. 1, 110; FIG. 2, 110; FIG. 3, 310). Such an actuator may include one or more of a solenoid or a motor. The latching may occur in various ways such as with the motion of latch jaws, motion of a latch hook, or through the raising and lowering of the modules (FIG. 1, 120; FIG. 2, 120; FIG. 3-FIG. 8, 305).

The specification and figures describe an additive manufacturing device and method of selectively coupling one of a number of modules to a carriage of the additive manufacturing device. The additive manufacturing device may selectively remove and return a number of modules from and to a parking station, respectively. The may be done during printing of a three-dimensional object such that multiple types of modules are used to form the three-dimensional object. This additive manufacturing device may have a number of advantages, including increasing the functionality of a FFF three-dimensional printing system by incorporating a number of different modules that perform a number of functions thereby enhancing the appearance and quality of the final object printed on the additive manufacturing device. Functionality, fidelity, and esthetics of the object may be improved. Additionally, printing speed may be increased.

What is claimed is:

1. An additive manufacturing device for forming a three-dimensional object comprising:
a parking station for receiving a number of removably seated modules; and
a movable carriage having a carriage latching mechanism for receiving one of the removably seated modules;
wherein movement of the carriage to a module transfers the module to the carriage.

2. The additive manufacturing device of claim 1, wherein the carriage latching mechanism is actuated by the relative movement between the carriage and the parking station.

3. The additive manufacturing device of claim 1, further comprising a latch actuator to actuate the carriage latching mechanism such that the module is latched to the carriage.

4. The additive manufacturing device of claim 1, wherein the removably seated modules comprise a cutter, a drill, a sander, a saw, and a welder, an electronic leads applicator, an integrated circuit applicator, a processor applicator, a memory device applicator, a sensor applicator, an energy source, a fluid depositor, a build material depositor, a sensor, or combinations thereof.

5. The additive manufacturing device of claim 1, wherein the deposition head is a fused filament fabrication head that deposits a hot melt build material to form the three-dimensional object.

6. The additive manufacturing device of claim 1, wherein at least one of the removably seated modules comprise a deposition head for depositing a build material for forming the three-dimensional object.

7. The additive manufacturing device of claim 1, wherein the parking station comprises a parking station latching mechanism to latch one of the removably seated modules to the parking station.

8. A method comprising:
with a processor, controlling a carriage of an additive manufacturing device to be moved to a parking station, the parking station comprising a number of removably seated modules; and
with the processor, controlling the carriage to transfer one of the removably seated modules from the parking station to the carriage by latching that module to the carriage.

9. The method of claim 8, wherein the carriage moves along two axes and wherein transferring one of the removably seated modules comprises latching that module to the carriage in response to motion of the carriage relative to the parking station along one of the two axes.

10. The method of claim 8, wherein transferring one of the removably seated modules includes latching that module to the carriage in response to activation of a latch actuator.

11. The method of claim 10, wherein the latch actuator latches the module without motion of the carriage relative to the parking station.

12. The method of claim 8, wherein at least one of the removably seated modules is a writing head for selectively defining portions of a three-dimensional object and wherein the writing head includes a deposition head, a radiation-emitting head, or combinations thereof.

13. The method of claim 8, further comprising storing, in a memory associated with the carriage, information regarding which module of the number of modules is parked in the parking station and where each module is parked in the parking station.

14. An additive manufacturing device comprising:
a processor;
a parking station to receive a number of removably seated modules; and
a movable carriage having a carriage latching mechanism, wherein the processor executes instructions to cause the carriage to be coupled to a first module by:
controlling the carriage to move in a first direction toward a parking station holding the number of modules until the carriage latching mechanism comes in contact with and captures the first module;
controlling the carriage to move in a second direction perpendicular to the first direction to unlock the first module from the parking station; and
controlling the carriage to move in a third direction parallel and opposite to the first direction such that the carriage latching mechanism pulls the first module out of the parking station.

15. The additive manufacturing system of claim 14, further comprising, with the processor, controlling the carriage to decouple with the first module by:
controlling the carriage to move in the first direction toward the parking station until the first module coupled to the carriage reaches an L-shaped path of a number of paths defined in the parking station;
controlling the carriage to move in a fourth direction perpendicular to the first direction and opposite to the second direction to lock the first module to the parking station
controlling the carriage to move in the third direction opposite to the first direction such that the carriage latching mechanism releases the first module.
